(19) United States
(12) Patent Application Publication
(10) Pub. No.: US 2003/0173001 A1
(43) Pub. Date: Sep. 18, 2003

(54) Stabilizer bar

(76) Inventor: James B. Smith, Wayne, MI (US)

Correspondence Address: BROOKS & KUSHMAN, 1000 TOWN CENTER 22ND FL, SOUTHFIELD, MI, 48075

(21) Appl. No.: 10/413,191

(22) Filed: Apr. 14, 2003

Related U.S. Application Data
(63) Continuation-in-part of application No. 09/997,908, filed on Nov. 30, 2001, now Pat. No. 6,547,894.

(51) Int. Cl. B60G 21/00

(52) U.S. Cl. 148/521; 280/124.152

(57) ABSTRACT

A method of making a stabilizer bar from a tubular blank to which a bonding agent is applied to the inside surface of opposite ends of the tube. The tube may be provided with tubular inserts that are also provided with a bonding agent. The bonding agent may be an adhesive that is cured and then the bonding agent is placed in an oven to melt the bonding agent. The ends are swaged to shape and the ends of the tube are trimmed and pierced to form a fastener eyelet in each end. The stabilizer bar is then heated for hot working to form the bends along the length of the bar. After forming to shape, the stabilizer bar is quenched and annealed.

### CROSS-REFERENCE TO RELATED APPLICATIONS

This application is a continuation-in-part of U.S. application Ser. No. 09/997,908, filed Nov. 30, 2001, now U.S. Pat. No. 6,574,894, issued Apr. 15, 2003.

### BACKGROUND OF THE INVENTION

1. Field of the Invention

The present invention relates to a stabilizer bar for a vehicle and to the stabilizer bar made according to the method.

2. Background Art

A stabilizer bar is a vehicle suspension component that forms part of the front suspension. A stabilizing bar is a hollow rigid bar that interconnects front suspension elements with the frame of the vehicle to improve stability.

A stabilizer bar has eyelets on opposite ends for receiving fasteners for connecting the bar to the suspension for the right wheel and left wheel. Stabilizer bars are formed from hollow tubes in a hot forming process. After forming, they are quenched in an oil bath or aqueous bath and then are annealed. One problem with prior art stabilizer bar manufacturing techniques is that if the stabilizer bar end is not completely closed prior to quenching, the quenching oil or aqueous solution may be drawn into the tube due to a vacuum created when the hot tube is cooled and becomes trapped within the tube. This can result in what appears to be an oil leak if the quench fluid later drips from the stabilizer bar. This can lead to unnecessary warranty costs if a customer believes that they have an oil leak but service technicians are unable to identify the source of the oil since the stabilizer bar is intended to be a hollow tube that does not ordinarily contain oil or other fluid.

Another problem encountered in the manufacturing of stabilizer bars is that if they have ends formed by squeezing a hollow tube to form a closed end it is difficult to maintain alignment of the top and bottom wall holes after forming and thermal treatment. If two holes are pierced through the two walls of a tube they may initially be aligned but as the tube is subsequently bent, quenched and annealed the two holes may become misaligned. In addition, if the end of a tube is squeezed to form the end of a stabilizer bar, there may be insufficient material for swaging into the desired shape. Also, with some stabilizer bar end designs a thicker eyelet section can be required.

One solution to the above problems has been to fill the ends of the tube used to manufacture the stabilizer bar with a solid metal cylindrical piece, or filler slug, that extends into the tube from both ends approximately 1 to 2 inches. The ends of the tube are then spin welded to the filler slug to provide a tube having solid ends that can be formed and trimmed to form the fastener eyelets. A stabilizer bar having spin welded tube end fillers can be quenched without any risk of drawing the quench fluid into the hollow tubular portion of the stabilizer bar. The problem of misalignment of the two holes after forming is also solved by welding the cylindrical piece to the tube end. However, this approach adds to the cost of materials required to make the stabilizer bar and also adds manufacturing operations that make it more expensive to produce a stabilizer bar.

There is a need for a method of making stabilizer bars having closed ends that do not draw quench fluid into the stabilizer bar during the manufacturing process that can result in difficult to identify oil leaks in a vehicle. More generally, there is a need for an improved manufacturing process for manufacturing parts from tubes having closed ends that do not distort the alignment of the holes in the ends when the tube is subsequently hot formed and quenched. Tubes fabricated in a hot forming process followed by a quenching operation may be used in applications other than the manufacture of stabilizer bars. Other such tube fabricating processes can benefit from a simple and inexpensive process for closing and sealing tube ends.

The above problems and needs are addressed by the invention as summarized below.

### SUMMARY OF THE INVENTION

According to one aspect of the invention, a stabilizer bar is provided for a vehicle that comprises a tubular member having two ends and an opening extending between the two ends. Each of the two ends is provided with a bonding agent on its inner diameter. Each of the ends have flat portions that are bonded together by the bonding agent to form a seal. The stabilizer bar further includes openings for receiving a fastener provided on each of the ends of the stabilizer bar. Bonding the ends prevents the openings in the stabilizer bar ends from becoming misaligned after forming and heat treating. The bonding agent sealing the ends of the stabilizer bar may be a powdered metal composition including chromium, nickel, boron, silicon and molybdenum. Other additives may include small amounts of cobalt, carbon, iron, or tungsten. The bonding agent could alternatively be electroless nickel or an epoxy composition. The bonding agent bonds the two ends of the tubular member. Boron or silicon may function as a flux agent that facilitates bonding to the tubular member.

According to another aspect of the present invention, a stabilizer bar for a vehicle is made according to a method that comprises initially providing a steel tubular member having an inner diameter and two open ends. A mixture of an adhesive and a bonding agent is applied to the inner diameter of both ends of the tubular member. The bonding agent may be cured if applied in a wet state and the tubular member is heated to cause the bonding agent to melt or react. The two ends of the tubular member are formed by flattening to form two flat ends while the bonding agent is heated to at least a temperature wherein the bonding agent is in a plastic state. The method is completed by trimming each of the two ends to form an eyelet for a fastener.

According to other aspects of the invention, the bonding agent may be a powdered metal composition such as a mixture of powdered metal such as chromium, nickel, boron, silicon and molybdenum. Other additives may include small amounts of cobalt, carbon, iron, or tungsten that may be used to change the final product properties such as the required ductility. The step of applying the bonding agent may be performed by either brushing or spraying the bonding agent or immersing the tubular member to apply the bonding agent to the inner diameter of the two ends of the tubular member. Alternatively, if the bonding agent is applied just prior to melting and forming other methods of applying the bonding agent may be used including inserting the bonding agent in a glass or silicone capsule containing the bonding agent that melts within the tube end and can function as a flux. The bonding agent may also be applied just prior to further processing by a metered injection of a dry powder, thick slurry or in a gel form. The bonding agent could also be applied by a thermal spray process and then subsequently remelted. The step of forming the two ends to form two flat ends may further comprise swaging each of the two ends together with the bonding agent sealing the two ends of the tubular member.

According to another aspect of the invention, the method may also include reheating the tubular member and bending the tubular member along its length while heated. After bending, the tubular member is quenched in a quenching fluid and then annealed. The tubular member may be quenched while the bonding agent seals the two ends of the tubular member to prevent the quenching fluid from being drawn into the tubular member.

According to other aspects of the invention, the stabilizer bar may further include a pair of tubular inserts that are placed within each end of the tubular member. A bonding agent may be applied to the interior and exterior surfaces of the tubular inserts so that the tubular inserts are bonded together into the ends of the tubular member.

The bonding agent can made of a fuseweld powder and adhesive mixture or could also be electroless nickel that may be applied in an immersion bath with an electrolytic charge. The bonding agent could alternatively be an epoxy resin. An epoxy resin or other bonding agent could initially be contained in a capsule that is placed in the tube end and then melted or broken to release the epoxy into the tube.

The aspects of the invention summarized above and additional features of the invention are more specifically described with reference to the attached drawings and following detailed description thereof.

### BRIEF DESCRIPTION OF THE DRAWINGS

FIG. 1 is a front perspective view of a stabilizer bar shown as it is incorporated in a front suspension of a vehicle;

FIG. 2 is a fragmentary cross-sectional view of an end of a tube used to manufacture a stabilizer bar that has been coated on its inner diameter with a mixture of a bonding agent;

FIG. 3 is a fragmentary cross-sectional view of an end of a stabilizer bar that has been heated to melt the bonding agent and flattened;

FIG. 4 is a fragmentary plan view of an end of a stabilizer bar that has been trimmed to form an eyelet for a fastener;

FIG. 5 is a flowchart showing the steps of the method of making a stabilizer bar according to the present invention;

FIG. 6 is a fragmentary cross-sectional view of an end of a tube used in the manufacture of a stabilizer bar that has been provided with an insert that has been coated on its inner diameter and outer diameter with a bonding agent;

FIG. 7 is a fragmentary cross-sectional view of an end of a stabilizer and insert that has been heated to melt the bonding agent and flattened; and

FIG. 8 is a cross-sectional view taken along the line 8-8 in FIG. 7.

### DETAILED DESCRIPTION OF THE PREFERRED EMBODIMENT(S)

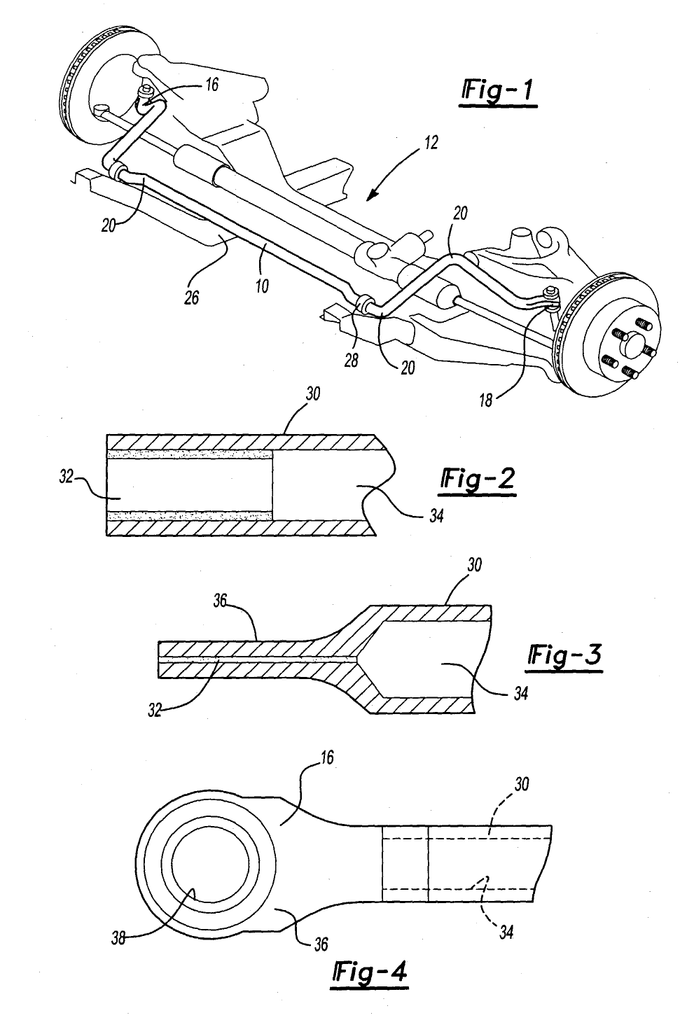

Referring now to FIG. 1, stabilizer bar 10 is shown as part of a front end suspension generally indicated by reference numeral 12. The stabilizer bar 10 includes a right end 16 and left end 18. The terms “right” and “left” as used herein correspond to relative vehicle positions from a driver's perspective wherein the driver of the vehicle is on the left side of the vehicle. The stabilizer bar 10 includes a series of bends 20 at locations dictated by the front suspension design. The stabilizer bar 10 is secured to the frame 26 by means of anchors 28 that journal the stabilizer bar 10 for limited arcuate movement.

Referring now to FIG. 2, one end of a tube 30 from which the stabilizer bar 10 is to be formed is shown with a bonding agent that, for example, could be a mixture 32. The mixture 32 could be of adhesive and a bonding agent such as a powdered metal composition of 94.6% nickel, 3.5% silicon and 1.9% boron. The bonding agent is applied to the inner diameter 34, or opening, of the tube. The mixture 32 may be applied by spraying or brushing. If subsequent processing steps are not performed immediately after the mixture 32 is applied, the adhesive portion of the mixture is permitted to cure prior to further processing as will be described below.

The mixture 32 may be applied by other methods and in other forms if subsequent processing steps are immediately performed. The mixture 32 may be applied by metered injection of dry powder, thick paste or gel. Instead of the mixture 32, the bonding agent could be another mixture, electroless nickel, or an epoxy composition.

Referring now to FIG. 3, an end of the stabilizer bar is shown with a flat end 36 formed by swaging the end of the tube 30 to close the end of the tube. The closed end of the tube is sealed by the bonding agent 32. The flattened end is formed when the tube has been heated and the bonding agent is either melted or at least in a plastic state. The thickness of the bonding agent 32 has been enlarged for illustrative purposes. The mixture 32 may also be described as powdered metal and boron contained in an adhesive matrix. The boron functions as a flux agent and may be absorbed into the walls of the tube 30 to improve the adhesion of the bonding agent of the mixture 32 to the inner diameter 34 of the tube 30.

Referring now to FIG. 4, a fully formed right end 16 of the tube 30 is shown. The end 16 includes a fastener eyelet 38, or opening, that is formed through the flat end 36 of the tube 30. Since the inner diameter 34 of the tube is sealed when the opening 38 is formed through the flattened end 36, no leak path is provided from the fastener eyelet 38 to the inner diameter 34, or opening, in the tube 30. Fluid will be prevented from being drawn into the tube during quenching. Misalignment of the openings 38 in the walls of the tube 30 is also precluded.

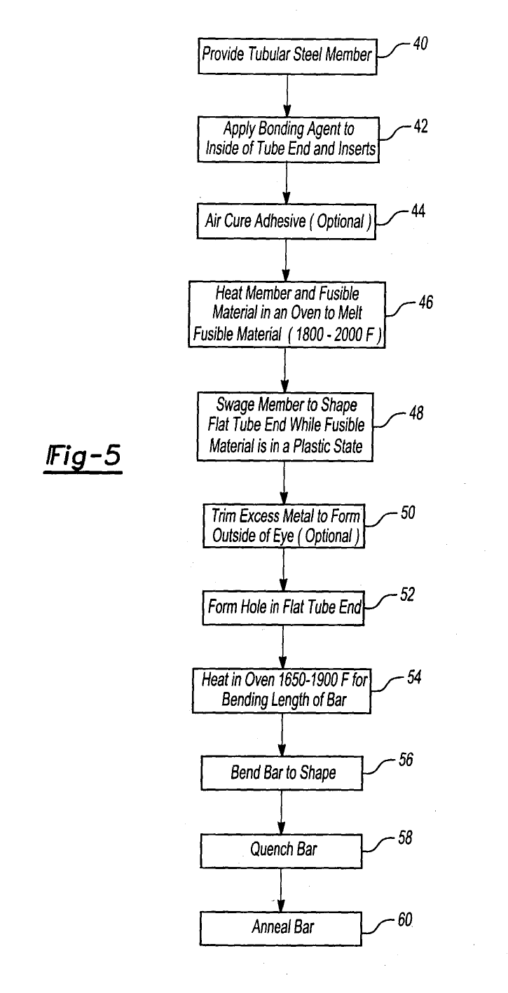

Referring now to FIG. 5, the steps of the process or method of making a stabilizer bar for a vehicle are illustrated as steps on a flowchart. Initially, a tubular steel member is provided at 40. A mixture 32 of an adhesive and a bonding agent may be applied to the inside of the tube end at 42. The bonding agent is preferably a powdered metal composition that includes a powdered metal that is compatible with the material of the tube 30 and also may include boron that facilitates bonding of the powdered metal to the tube 30.

Optionally, the adhesive is cured at room temperature or a somewhat elevated temperature at 44. After curing, the tubular steel member is heated in an oven to melt the bonding agent at 46. Depending upon the composition of the bonding agent and other process parameters, the oven temperature may be between 1800° F. and 2200° F.

The tubular member is then swaged at 48 to shape the end of the tubular member to form a flat tube end 36. The swaging operation may be performed while the bonding agent is at a temperature high enough to keep the bonding agent in a plastic state. The bonding agent could also be in a molten state if desired.

Excess metal is optionally trimmed from the tubular member to form the outer periphery of the fastener eyelet at 50 if necessary to meet design requirements. A hole is pierced, punched, bored, or otherwise formed in the flattened tube end at 52. After the ends are formed, the tubular member is heated in an oven at 54 to prepare the tubular member for hot forming. Depending upon the composition of the tubular steel member, the oven is heated to a desired temperature of, for example, 1650° F.-1900° F.

The bar is bent to shape by a hot forming operation such as forging or bending in a hydraulic press at 56. At this point, the stabilizer bar is completely formed to shape and may, for example, be bent in a configuration such as the stabilizer bar 10 shown in FIG. 1.

After forming, the stabilizer bar is quenched at 58. The quench fluid may be an oil bath or an aqueous solution. The bonding agent seals the tube end and precludes any of the quench fluid from being drawn into the tube. As noted above, prior art stabilizer bars fabricated from tubular stock tend to draw the quenching solution into the tube because a vacuum is formed when the hot tube is placed in the quench bath. After the tube is quenched, it may form a martensitic structure that is too brittle for use as a stabilizer bar. Therefore, the stabilizer bar is annealed at 60 wherein the martensitic structure is converted to an austensitic structure to provide strength and durability. After the stabilizer bar is annealed, it is gaged for quality control and painted prior to installation on a vehicle.

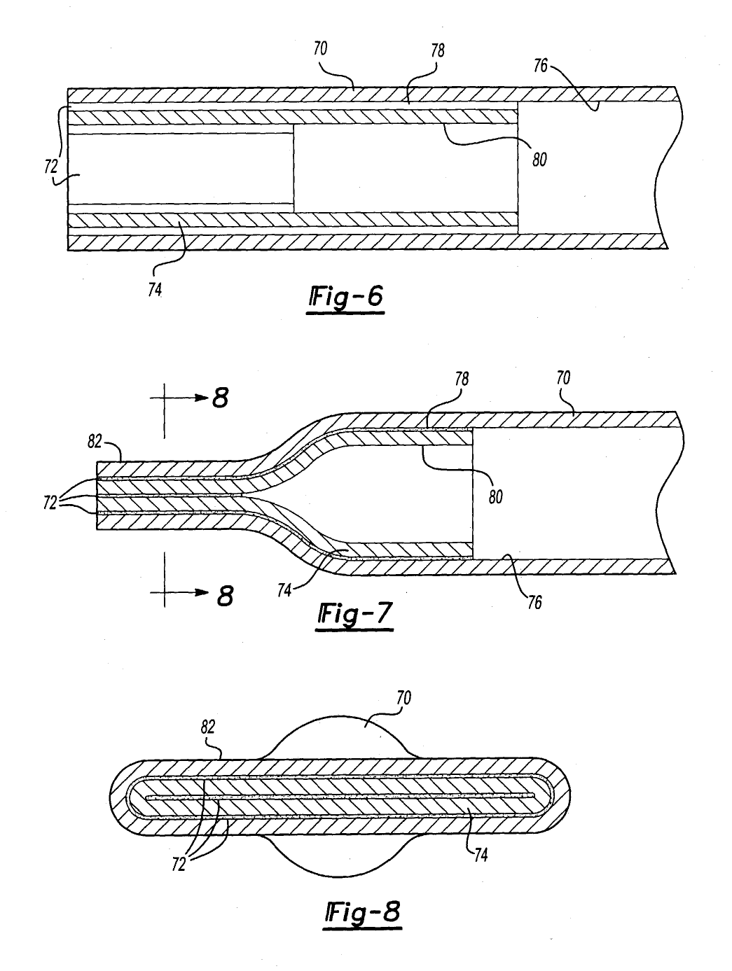

Referring now to FIG. 6, a tube used to make a stabilizer bar for a vehicle is indicated by reference numeral 70. A bonding agent 72 is applied to a tubular insert 74 or to both the tubular insert 74 and to the inner diameter 76 of the tube 70. The bonding agent 72 may be applied to the outer diameter 78 and inner diameter 80 of a tubular insert 74 by immersing, painting, spraying or otherwise applying the bonding agent 72 to the insert 74. The bonding agent may be an adhesive mixture and a fuseweld powder, an adhesive mixture and powdered metal, an epoxy composition, or electroless nickel. The bonding agent, regardless of its composition, functions to form a seal at the end of the tube 70 when the end is flattened.

Referring to FIG. 7, the tube 70 is shown with its end flattened to form a flat end 82. When the tube 70 is compressed, the tubular insert 74 is also compressed with the bonding agent 72 forming a seal between the outer diameter 78 of the tubular insert 74 and between the compressed walls of the tubular insert 74 at the inner diameter 80. The seal can be seen in FIG. 8 wherein the bonding agent 72 seals between the insert 74 and tube 70 in the area of the flattened end 82. After the flattened end 82 is formed, the end of the stabilizer bar may be completed as described with reference to FIG. 4 above wherein the fastener eyelet 38 is formed through the flattened end 82. The insert 74 provides additional material to allow for the formation of a more robust stabilizer bar end.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A stabilizer bar for a vehicle comprising:
a tubular member having two ends, the tubular member having an opening extending between the two ends;
each of the ends having a bonding agent deposited on their inner diameters, the ends each having flat portions that are bonded together to form a seal; and
each of the ends having a hole for receiving a fastener.

2. The stabilizer bar of claim 1 wherein the bonding agent is a powdered metal comprising powdered nickel and boron.

3. The stabilizer bar of claim 2 wherein the bonding agent bonds to the ends of the tubular member and the boron is a flux agent that facilitates bonding the ends of the tubular member.

4. The stabilizer bar of claim 2 wherein the bonding agent is an epoxy.

5. The stabilizer bar of claim 1 further comprising a pair of tubular inserts being disposed with one tubular insert being secured to each end of the tubular member.

6. The stabilizer bar of claim 5 wherein the bonding agent is applied to an interior and an exterior surface of the tubular inserts.

7. The stabilizer bar of claim 1 wherein the bonding agent is electroless nickel.

8. The stabilizer bar of claim 1 wherein the bonding agent is epoxy.

9. A stabilizer bar made in accordance with the method comprising:
providing a steel tubular member having an inner diameter and two open ends;
applying a bonding agent to the inner diameter of the two ends of the tubular member;
curing the bonding agent;
heating the tubular member and the bonding agent to melt the bonding agent;
forming two ends of the tubular member to form two flat ends while the bonding agent is heated to at least a temperature wherein the bonding agent is in a plastic state; and
swaging each of the two ends to form an eyelet for a fastener.

10. The stabilizer bar made according to the method of claim 9 wherein the bonding agent is a mixture of powdered metal and boron.

11. The stabilizer bar made according to the method of claim 9 wherein the step of applying the bonding agent is performed by brushing on the mixture.

12. The stabilizer bar made according to the method of claim 9 wherein the bonding agent comprises electroless nickel applied in an immersion bath with an electrolytic charge.

13. The stabilizer bar made according to the method of claim 9 wherein the bonding agent is an epoxy resin.

14. The stabilizer bar made according to the method of claim 13 wherein the epoxy is initially contained in a capsule that is placed in one of the ends of the tubular member and then melted to release the epoxy into the tube.

15. The stabilizer bar made according to the method of claim 9 wherein the step of forming the two ends to form two flat ends further comprises bonding the two ends together with the bonding agent sealing the two ends of the tubular member closed.

16. The stabilizer bar made according to the method of claim 9 further comprising:
reheating the tubular member;
bending the tubular member along its length while heated;
quenching the tubular member in a quenching fluid; and
annealing the tubular member.

17. The stabilizer bar made according to the method of claim 16 wherein during the step of quenching the tubular member, the quenching fluid being oil, the bonding agent seals the two ends of the tubular member to prevent the quenching fluid from being drawn into the tubular member.
